(19) United States
(12) Patent Application Publication
(10) Pub. No.: US 2018/0290225 A1
(43) Pub. Date: Oct. 11, 2018

(54) METHODS AND APPARATUSES FOR DISPENSING SOLDER

(71) Applicant: CommScope Technologies LLC, Hickory, NC (US)

(72) Inventors: Michael S. Riegel, Bonfield, IL (US); Michael Alexander Silber, Dallas, TX (US); Richard Alan Gudgel, Allen, TX (US)

(21) Appl. No.: 15/945,798

(22) Filed: Apr. 5, 2018

Related U.S. Application Data
(60) Provisional application No. 62/482,597, filed on Apr. 6, 2017.

(51) Int. Cl. B23K 3/06; G01G 17/06; G05D 7/06; H04L 12/58; H04L 12/26

(52) U.S. Cl. CPC B23K 3/0607; G01G 17/06; H04L 43/045; H04L 51/18; G05D 7/0617

(57) ABSTRACT

Automation of soldering work may be difficult, in part because present systems may be configured to dispense solder in a uniform preset amount. Provided are systems and methods in which soldering products (such as soldering paste and soldering wire) are dispensed adjustably. An example method includes receiving, by a computing device, a first weight reading of a part container prior to dispensing of solder product and a second weight reading of the part container after the solder product is dispensed. The computing device may determine an amount of dispensed solder product based comparing the first weight reading with the second weight reading, and may determine whether the amount of dispensed solder product falls within an accepted range. If not, a second length of time of different length may be generated for use in a future dispensing of the solder product.

### CROSS-REFERENCE TO RELATED APPLICATION

The present application claims priority under 35 U.S.C. § 119 to U.S. Provisional Application Ser. No. 62/482,597, entitled METHODS AND APPARATUSES FOR DISPENSING SOLDER, filed on Apr. 6, 2017, the entire contents of which are incorporated by reference herein for all purposes.

### FIELD

Aspects of the present disclosure relate generally to the manufacturing of equipment, such as communications equipment.

### BACKGROUND

Solder refers to many different types of alloys that may be used in a variety of applications, but most relevant to the present disclosure are the solders used in electrical and electronics work. These solders may include alloys of, for example, lead and tin, as well as lead-free solder used in a variety of electronics applications. In some aspects, solder may be applied from a spool of solder wire, and the solder wire may include a rosin core. In other aspects, solder is applied as a paste. In still other aspects, solder may be applied as a preformed shape specially designed for a particular application. In each case, the solder may be heated and applied to two elements that are to be electrically connected to each other.

Although in the past solder has been applied by hand, time and financial constraints have resulted in increasing application of solder via automated or other mechanical systems. The mass production of various electrical and electronics equipment, such as communications equipment, has only increased a desire in the field of equipment manufacturing for efficient and effective manufacturing techniques.

### SUMMARY

A number of problems have been identified in the sub-field of solder dispensing. First, some solder dispensing techniques, including some solder dispensing systems, may ineffectively apply the solder, resulting in a degrading of electrical or signal performance. This may result in over-applying or under-applying of solder. A common usage of solder is to couple a connector to a cable, such as a connector to either an inner or outer conductor of a coaxial cable. However, if solder, solder paste, solder rosin, and/or flux is incorrectly or ineffectively placed, the liquefaction and re-solidifying of the solder or its components may result in a degraded electrical connection or create unwanted pathways (including residue pathways) between the inner conductor and outer conductor. Such degraded solder connections may result in an interconnection between cable and connector that has degraded electrical characteristics such as passive intermodulation or an altered voltage breakdown potential.

Second, some solder paste dispensing apparatuses and methods may use optical-based methods for determining the amount of solder paste to be dispensed. For example, some systems may use a camera (e.g., still camera, video camera) or even a human worker's eyes to determine a location of a connector into which solder paste is to be dispensed, and to confirm that the connector is beneath the dispenser. The human or automated worker may then dispense solder paste into the connector until either visual conditions are satisfied (e.g., until the connector appears to be ‘full’) or until a timer has elapsed (e.g., for two seconds). These techniques may be inaccurate. For example, visual dispensing may misestimate the amount of solder paste dispensed in part because air gaps in the applied solder paste may obfuscate an amount of solder paste actually in the connector. Alternatively, time-based dispensing may result in an incorrect amount of solder paste being dispensed because the solder paste may flow through the dispenser and into the connector at different rates based on environmental factors (e.g., a temperature in the factory) or composition factors (e.g., solder paste may not flow uniformly across a mixed batch of solder paste).

Third, manufacturing of a single assembly or sub-assembly may require soldering at multiple different locations within the assembly. Each of these soldering jobs may require a different amount of solder to couple the components correctly. A first soldering location may require a first amount of solder wire, and a second soldering location may require a second amount of solder wire different from the first amount, Automation of such multiple-location soldering work may be difficult, in part because automated systems may be configured to automatically dispense solder in a uniform preset amount. Automating this multiple-location soldering using present methods and devices may require multiple workstations, each with a soldering unit configured to dispense a different amount of solder, or reprogramming of a soldering unit at a single workstation to dispense the first amount, then the second amount, and so on.

To address these and other identified problems, aspects of the present disclosure provide a method including: receiving, by a computing device and from a balance, a first weight reading of a part container. The method also includes transmitting a command to dispense a solder product into the part container for a first length of time. The method also includes receiving, by the computing device and from the balance, a second weight reading of the part container. The method also includes determining, by the computing device, an amount of dispensed solder product based on a comparison of the first weight reading and the second weight reading. The method also includes determining, by the computing device, that the amount of dispensed solder product does not fall within an accepted range. The method also includes generating, by the computing device and in response to the determining that the amount of dispensed solder product does not fall within the accepted range, a second length of time to be used in a future dispensing of the solder product, where the second length of time differs from the first length of time.

Aspects of the present disclosure provide a method including: receiving, by a computing device and from a balance, a first weight reading of a pallet including a plurality of parts. The method also includes positioning, by the computing device, a solder product dispensing nozzle over a first part of the plurality of parts. The method also includes transmitting a command to the solder product dispensing nozzle to dispense a solder product into the first part for a first length of time. The method also includes receiving, by the computing device and from the balance, a second weight reading of the pallet including the plurality of parts and dispensed solder product. The method also includes determining, by the computing device, an amount of the dispensed solder product based on a comparison of the first weight reading and the second weight reading. The method also includes determining, by the computing device, that the amount of dispensed solder product does not fall within an accepted range. The method also includes generating, by the computing device and in response to the determining that the amount of dispensed solder product does not fall within the accepted range, a second length of time, where the second length of time differs from the first length of time. The method also includes positioning, by the computing device, the solder product dispensing nozzle over a second part of the plurality of parts. The method also includes transmitting a command the solder product dispensing nozzle to dispense a solder product for the second length of time.

Aspects of the present disclosure provide a method including: receiving, by a computing device, user input indicating a selected part. The method also includes retrieving, from a database, detailed information associated with the selected part. The method also includes displaying, on a display associated with the computing device, a first operation from a sequence of soldering operations to be performed for the selected part, where the detailed information includes, for each soldering operation of the sequence, a visual indicator of a location on the selected part to perform the soldering operation, an amount of a solder product associated with the soldering operation, and a temperature setting for the soldering operation. The method also includes receiving a command to dispense the amount of solder product associated with the first operation. The method also includes transmitting an instruction to dispense the amount of solder product based on the command.

### BRIEF DESCRIPTION OF THE DRAWINGS

FIG. 1 is a perspective view of components of an exemplary solder paste dispensing apparatus.

FIG. 2 is a block diagram of the exemplary solder paste dispensing system.

FIG. 3 is an exemplary process flowchart of dispensing solder paste using the system of FIG. 2.

FIG. 4 illustrates an exemplary user interface that may be used in conjunction with the solder paste dispensing system of FIG. 2.

FIG. 5 is an exemplary solder wire dispensing apparatus.

FIG. 6 is a block diagram of an exemplary solder wire dispensing system.

FIG. 7 is an exemplary process flowchart of dispensing solder wire using the system of FIG. 6.

FIG. 8 illustrates an exemplary user interface that may be used in conjunction with the solder wire dispensing system of FIG. 6.

FIG. 9 illustrates hardware elements that can be used to implement any of the various computing devices discussed herein.

### DETAILED DESCRIPTION

The description provided herein is best appreciated with reference to the accompanying drawings, in which certain exemplary embodiments are shown. Aspects of the present disclosure may, however, be embodied in many different forms and should not be construed as limited to the exemplary embodiments that are pictured and described herein. Rather, these illustrated embodiments are provided so that this disclosure will be thorough and complete, and will fully convey the scope of the teachings provided herein to those skilled in the art. It will also be appreciated that the embodiments illustrated herein may be combinable in any way and/or combination to provide many additional embodiments.

Unless otherwise defined, all technical and scientific terms that are used in this disclosure have the same meaning as commonly understood by one of ordinary skill in the field to which this disclosure belongs. The terminology used in the below description is for the purpose of describing particular embodiments only and is not intended to be limiting. As used in this disclosure, the singular forms “a”, “an” and “the” are intended to include the plural forms as well, unless the context clearly indicates otherwise. It will also be understood that when an element (e.g., a device, circuit, etc.) is referred to as being “connected” or “coupled” to another element, it can be directly connected or coupled to the other element or intervening elements may be present. In contrast, when an element is referred to as being “directly connected” or “directly coupled” to another element, there are no intervening elements present.

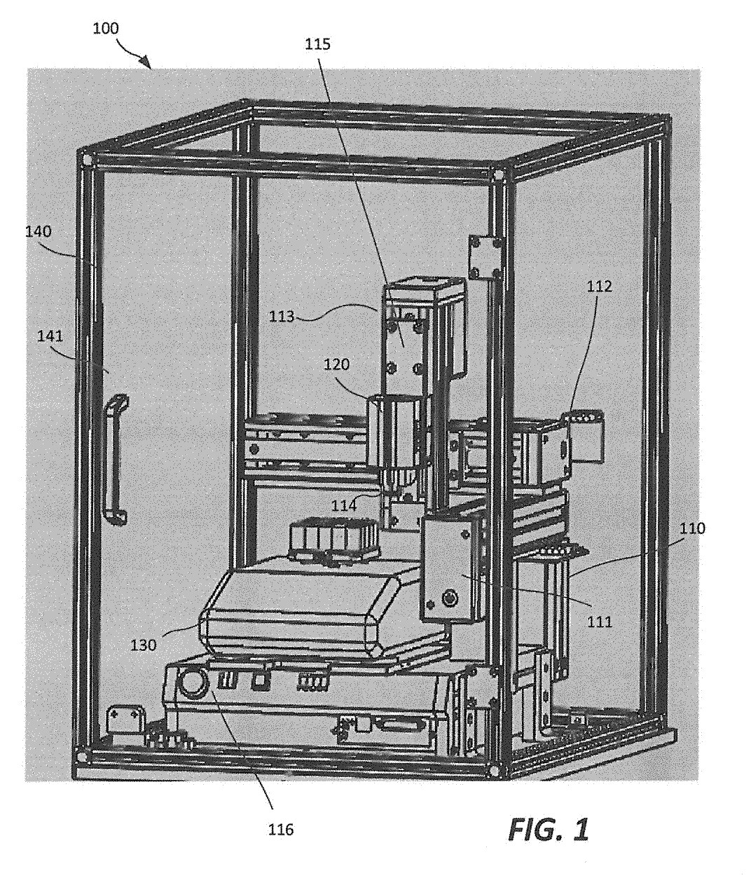

FIG. 1 is a perspective view of components of an exemplary solder paste dispensing apparatus 100. The a solder paste dispensing apparatus 100 may include an arm assembly 110, a dispenser 120, and a balance 130. The arm assembly 110 may be a multi-axial arm assembly, and may include a first axis arm 111, second axis arm 112, and third axis arm 113. The axis associated with each arm may be referred to herein as a X-axis, a Y-axis, and a Z-axis respectively.

The dispenser 120 may include one or more tubes (which are not illustrated in FIG. 1 to simplify the figure) coupled to a dispensing nozzle (also not illustrated in FIG. 1) having a defined or variable opening for dispensing solder paste. Other equipment (not illustrated in FIG. 1), such as pneumatic equipment, fluid handling equipment, pumps, and/or the like, may drive solder paste from a first location toward the nozzle via the one or more tubes. For example, the first location may be a vat, storage tank, storage container or other storage location holding pre-mixed solder paste. This pre-mixed solder paste may be carried to the dispensing nozzle via the one or more tubes as the result of applied pressure or force (including gravity). The dispensing nozzle may be electromechanically controlled to open for a variable length of time, thereby dispensing the solder paste. Calculation of the variable length of time will be further discussed below. Additionally or alternatively, the applied pressure or force may be increased for a variable length of time while the dispensing nozzle is in a dispensing configuration, thereby resulting in the dispensing of the solder paste.

The dispensing nozzle may be moved to various positions based on the movement of nozzle head 114, which is mounted on a mount 115 of the third axis arm 113. To move the dispensing nozzle along the third axis, control signals may be communicated to actuators (and/or other motion-causing devices, such as motors, pulleys, gears, and the like) that are associated with the third axis arm 113. These control signals may result in the raising and lowering of the nozzle head 114. In other words, the nozzle head 114 may move along the Z-axis.

The third axis arm 113 may be itself mounted on the second axis arm 112. To move the dispensing nozzle along the second axis, control signals may be communicated to motion-causing devices associated with the second axis arm 112. These control signals may result in the movement of the third axis arm 113 along the second axis. In the perspective view of FIG. 1, this is toward the left and right of the figure. In other words, the nozzle head 114 and the third axis arm 113 may move along the Y-axis.

The second axis arm 112 may be itself mounted on the first axis arm 111. To move the dispensing nozzle along the first axis, control signals may be communicated to motion-causing devices associated with the first axis arm 111. These control signals may result in the movement of the second axis arm 112 along the first axis. In the perspective view of FIG. 1, this is toward the front and back of the figure. In other words, the nozzle head 114, the third axis arm 113, and the second axis arm 112 may move along the X-axis.

The use of three axial movement is merely exemplary and for illustrative purposes only. Fewer axes (e.g., two axes) or more axes (e.g., four axes) of movement may be provided depending on the application or location of solder paste. For example, a tilting arrangement may be provided on mount 115 such that the dispensing nozzle, and a longitudinal axis thereof, may tilt away from being substantially parallel to the third axis arm 113.

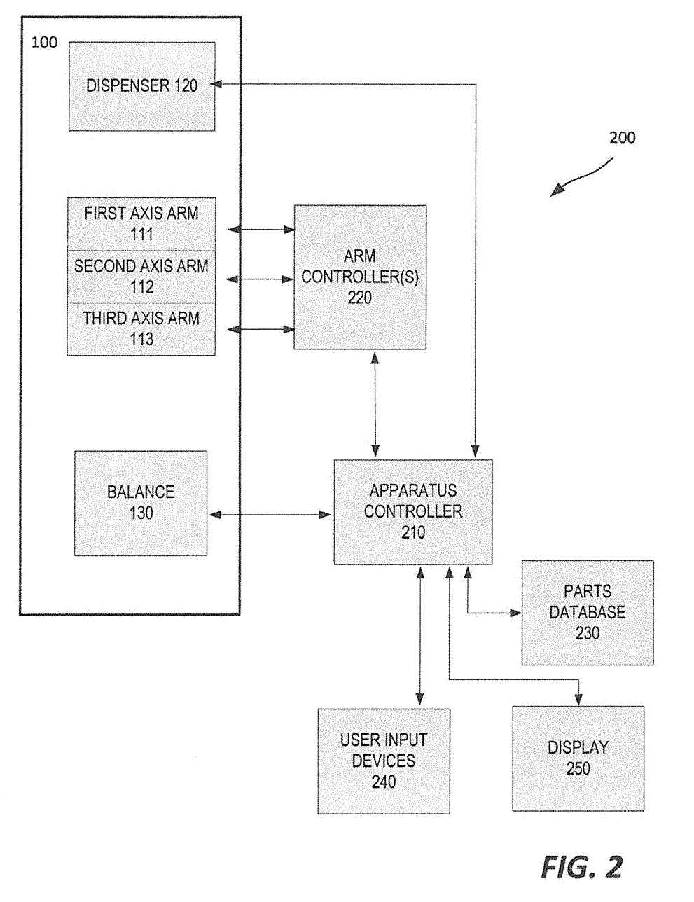

Control of the solder paste dispensing apparatus 100 via an apparatus controller (for example, apparatus controller 210 of FIG. 2) will be discussed in greater detail below; however in some aspects, physical controls 116 of the arm assembly 110 may be provided to provide local control of the arm assembly for safety reasons. These physical controls may include, for example, an emergency stop button. Such physical controls may be optional, and instead operator interaction with the solder paste dispensing may be limited to interaction with the apparatus controller discussed herein.

The balance 130 may be arranged and leveled on a surface of the solder paste dispensing apparatus or any other appropriate surface. In some aspects, this surface may be a surface of the arm assembly. Balance 130 may be an accurate balance having several degrees of precision readability, such as milligram readability. In some aspects, finer or coarser readability precision may be preferred, and micogram or gram readability (as examples) may be used instead. The balance 130 may include one or more communication interfaces (not shown) such as an Ethernet interface, RS-232 interface, or Universal Serial Bus (USB) interface for communicating, either uni-directionally or bi-directionally, with an apparatus controller.

Although FIG. 1 illustrates the above discussed components being arranged within an enclosure 140 having a door 141, it should be understood that the enclosure 140 is optional.

FIG. 2 illustrates a block diagram of the exemplary solder paste dispensing system 200. The solder paste dispensing system 200 may include an apparatus controller 210, which may be programmed to provide overall control of the operation of the solder paste dispensing system 200. The apparatus controller may retrieve or receive information from the dispenser 120, the first axis arm 111, the second axis arm 112, the third axis arm 113, the arm assembly 110, and the balance 130, and/or components of each, either directly or indirectly. For example, arm controllers 220 may be provided to provide independent axial movement of each arm 111, 112, and 113 in the manner discussed above. In some aspects, there may be a single arm controller 220 provided in either software, firmware, hardware or a combination thereof, and either as a component within the arm assembly 110 and/or the apparatus controller 210. Additionally or alternatively, each arm 111, 112, and 113 may have a respective arm controller 220 provided in either software, firmware, hardware or a combination thereof and installed within the arm assembly 110 and/or the apparatus controller 210. The arm controller 220 may receive instructions from the apparatus controller 210 and translate the instructions into movement commands along one or more axes. In some aspects, the arm controller 220 may receive position or other data from the first axis arm 111, second axis arm 112, and/or third axis arm 113 and transmit the same to the apparatus controller for feedback and/or error handling.

The apparatus controller may transmit instructions to dispenser 120 or a component thereof to dispense solder paste for a calculated amount of time.

A parts database 230 may be provided, either as a component of the apparatus controller 210 or as a separate device (e.g., a separate database or database program operating on a same processor as apparatus controller 210 or a different processor).

As discussed in greater detail below, an operator may select a part to which solder paste is to be applied using a user interface tool. Detailed information associated with each part may be stored in the parts database 230. The detailed information may include a part name, part quantity (for example, when multiple similar parts may be loaded into the solder paste dispensing apparatus 100 simultaneously), part layout, amount and/or range of amount of acceptable solder dispensing, solder dispensing temperature, and/or default information about dispensing solder (e.g., time). The retrieved detailed information may be used to configure the apparatus controller 210, and by extension the solder paste dispensing system 200, into an initial solder paste dispensing state.

The apparatus controller 210 may receive information from the balance 130 discussed above. As solder paste is dispensed onto a part loaded on the balance 130, the weight of the part will change. The balance 130 may capture this dispensing and transmits the change in weight to the apparatus controller via the one or more communication interfaces.

Also illustrated in the system of FIG. 2 are user input devices 240, which may include a remote control, keyboard, mouse, touch screen, microphone, or the like. Information may be displayed to an operator via display 250 (which may in some aspects include user input devices 240).

Although the blocks of FIG. 2 are illustrated as separate components, one or more of the devices and/or subsystems may be combined into a single assembly. For example, a single computing device may include the apparatus controller 210, the parts database 230, the arm controller(s) 220, and appropriate interfaces to couple with the user input devices 240 and the display 250.

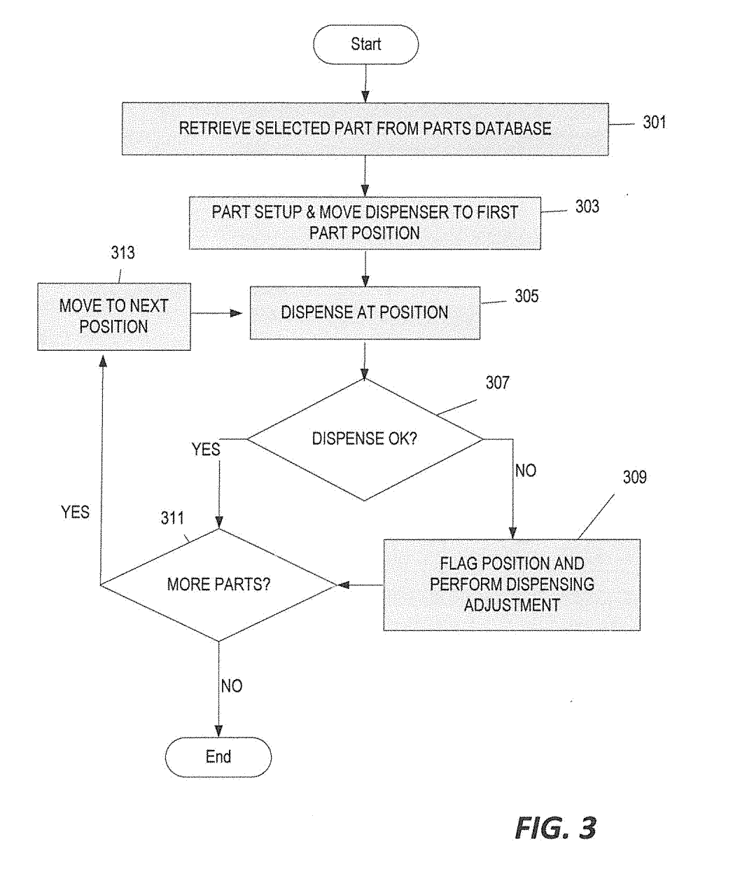

FIG. 3 is an exemplary process flowchart of dispensing solder paste using the system of FIG. 2. The method of FIG. 3 may commence at operation 301 upon selection of a part from a parts database (e.g., the parts database 230). This selection may be performed by an operator using a user interface, although in some aspects selection of a part may be performed via other input methods. For example, an operator may scan a barcode or radio frequency identification (RFID) tag on a part or parts container, and a part identifier derived from the scanning may be used to look up detailed information about the scanned part. Alternatively, the solder paste dispensing system may be installed in an assembly line or other location where solder paste dispensing is to be performed for a single part type or component type, and thus the detailed information may be automatically selected. In such an aspect, the parts database 230 may be optional.

In operation 303, the retrieved detailed information about the part is examined and the arm assembly 110 is operated first in an initial part setup mode. This may include moving arm assembly 110 out of the way of a loading surface (e.g., the top surface of the balance 130) for positioning and leveling of the part in the solder paste dispensing apparatus. This may include the operation of one or more of the first axis arm 111, second axis arm 112, and/or third axis arm 113 into an out-of-the-way position. The part or part container may then be loaded into the apparatus and placed on the loading surface. The operator may ensure that the part or part container is level, and then may select a command indicating that an initial weight of the part or part container should be taken (e.g., the operator may select a “tare” operation via a user input interface). In some aspects, the initial weight of the part or part container may be stored in the database and the use of a “tare” operation may be optional.

Once the part has been setup in the apparatus, and still within operation 303 of FIG. 3, the dispensing nozzle may be moved to a first dispensing position or location. As discussed above, this may include the operation of one or more of the first axis arm 111, second axis arm 112, and/or third axis arm 113 to position the nozzle at the selected first location. This first dispensing location may be stored in the parts database 230 during a learning process or procedure. For example, while the system operates in a setup or tooling mode, a supervising technician or engineer may manually operate the actuators of the arm assembly 110 to position the nozzle into an appropriate first dispensing position and then may capture the appropriate coordinates (e.g., X-coordinate, Y-coordinate, Z-coordinate) of the dispensing nozzle in space, which are then stored in the database. This information may then be retrieved by the system when operating in a dispensing or production mode.

At operation 305, the solder paste may be dispensed into the part or part container. For example, the part may be a pin for an inner conductor of a coaxial cable assembly. The solder paste may be dispensed by the dispenser for a first amount of time, which may be stored in the parts database 320 and which may be specific to the part or part container. For example, the first amount of time may be 1.2 seconds, although other lengths of time or periods are possible.

After dispensing has occurred (e.g., after elapsing of a timer or after receiving an indication from the dispenser that dispensing has completed), the system may proceed to operation 307. In operation 307, a new weight of the part or part container may be received by the apparatus controller 210 from the balance 130. This new weight may be compared by the apparatus controller 210 to the initial weight of the part or part container. The apparatus controller 210 may determine whether the dispensed weight (which may be the difference between the new weight and the initial weight) is within an acceptable range parameter. If the dispensed weight is acceptable (YES branch from operation 307) then the method may proceed to the next part, if any (operation 311).

If the dispensed weight is unacceptable, either because of an overdispensing (overweight) or underdispensing (underweight) condition, then the method may proceed to operation 309. In operation 309, the position may be flagged or otherwise indicated to an operator that there was a problem dispensing at the position. For example, this may be indicated on a display screen, recorded in a database (which may be different from the parts database 320), and/or otherwise logged for corrective action.

Additionally or alternatively, in operation 309, a dispensing adjustment operation may be performed. For example, if the calculated weight is below the acceptable range, the length of time for the next dispensing may be increased (with the aim of increasing the amount of solder paste dispensed). Alternatively, if the calculated weight is above the acceptable range, the length of time for the next dispensing may be decreased (with the aim of decreasing the amount of solder paste dispensed.) The increase or decrease in the dispensing time may result in an adjusted dispense time.

In some aspects, operation 309 may use multiple data points to determine whether to adjust the dispensing time. For example, the system might not adjust the dispensing time if only a single dispense is underweight or overweight, and might instead examine the previous two, three, or more dispenses to determine whether adjustment is desirable. Additionally, the amount of increase or decrease in the adjusted dispensing time may be based on one or more factors, such as a difference between a target weight and the dispensed weight of a first solder paste dispensing and/or an averaging of the difference between the same over multiple solder paste dispensings.

In some aspects, operation 309 might be performed even if the amount of solder paste dispensed is within an acceptable range or production tolerance. For example, solder paste dispensing system 200 might recognized that, although the previous several dispenses are within the acceptable range, each has been underweight. The solder paste dispensing system 200 may automatically increase the length of time solder paste is dispensed in an attempt to bring the amount of dispensed solder paste closer to the target weight (e.g., to achieve a tighter tolerance).

This method may provide advantages over visual-based or time-only-based systems in that a calculated amount of weight of dispensed solder may be better correlated to an acceptable joining of components once the solder is melted and then re-solidified during a later heating and cooling process. In contrast, visual observation of the dispensed solder paste may be unable to detect air gaps or pockets in the dispensed solder, and time-only-based systems may be unable to adapt to environmental or chemical conditions associated with the dispensing of solder. An example environmental condition may be that the temperature in a factory where the apparatus is located may result in increased or decreased solder paste flow. An example chemical condition may be that as solder paste is dispensed from a pre-mixed batch of solder paste, solder may flow at a different rate in a first dispensing than in a second subsequent dispensing, in part because the chemical composition of the batch may change with each dispensing. These environmental and chemical conditions may be difficult to ascertain, and adapting a dispensing time of a solder paste dispenser based only on visual observations may create unwanted inconsistency between parts to which solder paste is applied.

Returning to the illustrated operations of FIG. 3, at operation 311 a determination is made as to whether additional parts remain to be soldered. This operation may be arrived at either if the dispensing is acceptable (YES branch from operation 307) or not acceptable (NO branch from operation 307, via operation 309). If solder paste is to be applied to additional parts (YES branch from operation 311) (e.g., other parts within the part container), then the method proceeds to operation 313). Otherwise (NO branch from operation 311) the process terminates. A determination as to whether additional parts are to be soldered may be based on input from the operator (e.g., the operator selects a “move” command, including a “move to next part” command), data comprised within the detailed information retrieved from the parts database, and/or other methods. Solder paste may be dispensed into the subsequent part using the adjusted dispense time.

In some aspects, a sub-operation associated with the termination of the process illustrated in FIG. 3 may include moving the arm assembly 110 out of the way in a similar manner as described above. In this way, an operator may be able to remove a part or part container from the solder paste dispensing apparatus 100.

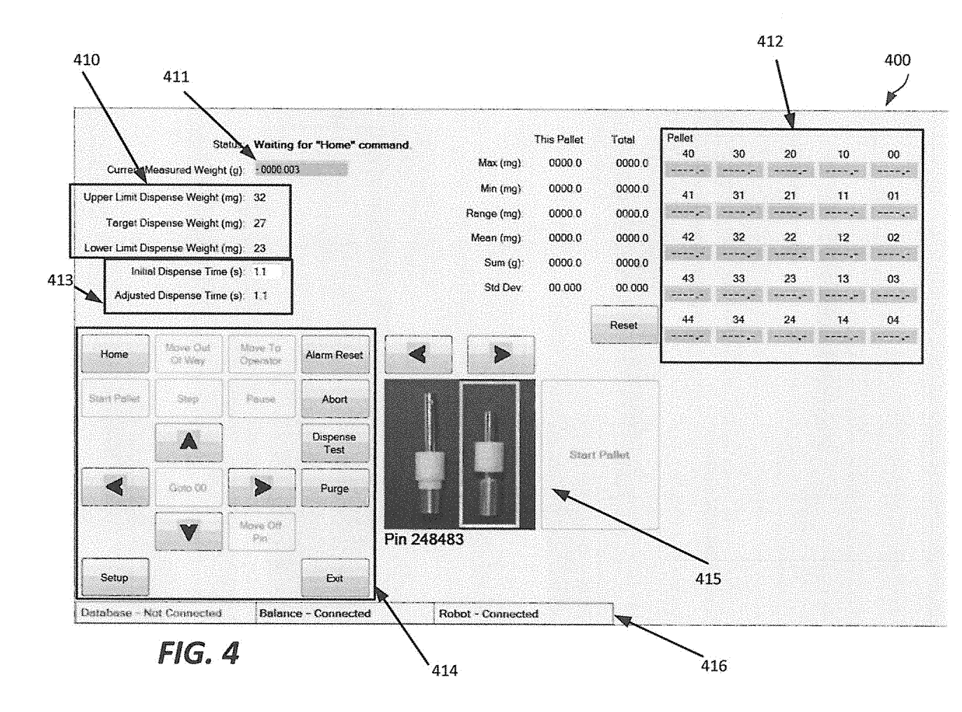

FIG. 4 illustrates an exemplary user interface that may be used in conjunction with the solder paste dispensing system of FIG. 2. In some aspects, the user interface illustrated in FIG. 4 may be presented on the display 250 discussed above and be configured to receive input commands via the user input devices 240 discussed above.

The user interface 400 illustrated in FIG. 4 is merely an example, and more or less information, and/or a greater or fewer number of controls, may be presented. For example, a supervisor or engineer may have a greater number of controls than a line worker. Such rights and access may be based on an identification of a user and/or entry of a password.

As discussed above, an operator may select a part. This may include selecting the part using part selection tool 415, which may display a photographic indicator of the part. An operator may toggle through various parts using the arrow keys above part selection tool 415. In some aspects, the operator may instead select the part, which may instantiate a separate user interface in which a part may be searched and selected. Visual representation of the selected part may assist in reducing mistakes between parts that have similar identification codes (e.g., Pin 24843 and Pin 28483) but are associated with different detailed information in the parts database.

As indicated by pallet matrix 412, and as discussed above, the solder paste dispensing system 200 may dispense solder paste into multiple components stored on a part container (here, an insertable pallet). Each component may be a separate component—in the example of FIG. 4, there may be 25 connector pins loaded into the insertable pallet which may be used in 25 different connector assemblies. Such numbers are merely exemplary and may be different depending on the dimensions of the surface of the balance 130 and the arm assembly 110. Solder paste may be dispensed into the parts in a sequential fashion beginning with a top right location (e.g., pallet location ‘00’) and proceeding to a bottom left location (e.g., pallet location ‘44’).

As discussed above, weight information may be received from the balance and displayed in a weight indicator 411. This amount may change as solder paste is dispensed into the part container or a part thereon.

Detailed information about the part may be presented in first display portion 410 and second display portion 413. The first display portion may include, for example, information about the lower limit dispense weight, target dispense weight, and upper limit dispense weight. The second display portion may include information about the initial dispense time, and the adjusted dispense time. Connection status to the balance, arm assembly, and parts database may be provided in a connection status panel 416.

User interface controls 414 may be provided to instantiate or modify operation of the solder paste dispensing system 200. These controls may include a “purge” command to clear air or solder paste from the one or more tubes feeding the dispensing nozzle and/or the dispensing nozzle itself. The controls may include a manual “dispense” command to manually feed solder paste through the assembly for testing or initializing purposes. In addition to the “move out of the way” command discussed above (in which the arm assembly 110 moves to a location to maximize access to the balance surface), a “move to operator” command may cause the arm assembly 110 to move the dispensing nozzle to the operator for cleaning and maintenance thereof.

Other user interfaces may be provided to the operator, either as portions of the user interface 400 illustrated in FIG. 1 or as separate interface displays. For example, a parts editing interface may be provided to add, modify, and/or delete parts from the parts database. As another example, a configuration interface may be provided for initial setup and configuration of the solder paste dispensing system 200.

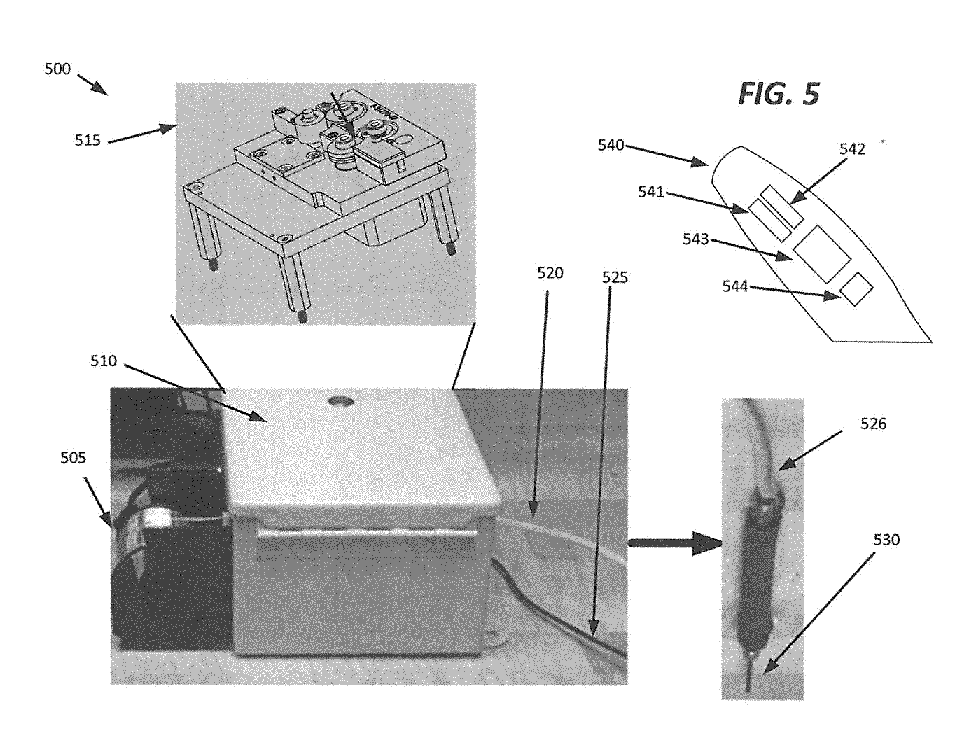

Previously discussed aspects use an example of dispensing of solder paste, which may be in a viscous or fluid form. However, the present disclosure is not limited thereto, and techniques discussed herein may be applicable to the dispensing of solder wire, which may be more solid than the solder paste. FIG. 5 is an exemplary solder wire dispensing apparatus 500. As provided, solder wire, including pre-manufactured solder wire having a rosin or resin core (e.g., a flux core) may be spooled and loaded into spool holder 505. A end strand of the spool of solder wire may be fed into a first port of a housing 510. Feed components therein (not illustrated in FIG. 5) may advance the solder wire through a V-cut assembly 515, which is optional. Forming a V-shaped cut in the solder wire to partially expose the rosin/flux core therein may assist in a more uniform melting of the flux core and the surrounding solder (which may have different melting temperatures). This exposure may reduce splattering or bubbles caused by the flux core.

As with the dispenser 120 of the solder paste dispensing apparatus illustrated in FIG. 1, the feed components within housing 510 may include one or more communication interfaces (not shown) such as an Ethernet interface, RS-232 interface, or Universal Serial Bus (USB) interface for communicating, either uni-directionally or bi-directionally, with an apparatus controller (not shown in FIG. 5). The feed components may receive instructions to feed variable lengths of solder at variable speeds. For example, a first length may be fed at a first rate, and a second length which may be different from the first length may be fed at a second rate that may differ from the first rate.

Further feed components may feed v-cut solder wire out of housing 510 and into guide tube 520. This tube may be joined with tip cable 525 in a common jacket 526. Tip cable 525 may provide power to solder tip 530, which may heat to a variable temperature. In some aspects, an increase in voltage and/or current carried by tip cable 525 may result in an increase in temperature of the solder tip 530. An opening may be provided at solder tip 530 through which fed solder wire may exit guide tube 520 and come into contact with the work piece to be soldered.

An operator may hold solder tip 530 in one hand, and may operate the solder wire dispensing apparatus 500 using a remote control 540 held in the other hand. The remote control 540 may have multiple light emitting diodes (LEDs) 541 and 542 and multiple push buttons 543 and 544 although the number and positioning of such LEDs and buttons are provided as one example. The first push button 543 may cause, when pressed, a pre-determined length of wire to be dispensed for pre-tinning the solder tip 530. This operation may be performed variably and intermittently through a soldering workflow based on an amount of solder or flux residue that accumulates on the tip. Once the tip is cleaned, reapplication of a small amount of tin to the tip (e.g., through pre-tinning) may increase a soldering speed and may enable more effective soldering joints.

The second push button 544 may cause, when pressed, execution of a next step in a sequence of soldering steps. As with the solder paste dispensing system 200 illustrated in FIG. 2, instructions may be stored in a database to perform multiple soldering operations sequentially. Whereas the given example discussed above with reference to solder paste dispensing system 200 was performing a similar solder paste dispensing operation for each of a plurality of parts (e.g., each of a plurality of connector pins), an example provided here is that solder wire dispensing apparatus 500 may be used to solder multiple joints on a same assembly or sub-assembly. In other words, multiple soldering operations may be performed on the same work piece or work pieces. Each of these may require a different amount (measured in length) of solder wire, which may need to be at different temperatures to join the components. Solder wire dispensing apparatus 500 may receive instructions from a parts database via an apparatus controller to pre-heat the solder tip 530 to a soldering temperature, and feed a length of solder wire at an associated speed. A first LED 541 may be illuminated during the pre-heat operation and a second LED 542 may be illuminated during the feed operation. The remote control 540 may be wired or wirelessly coupled to the apparatus controller (not shown in FIG. 5) and/or the feed components within housing 510.

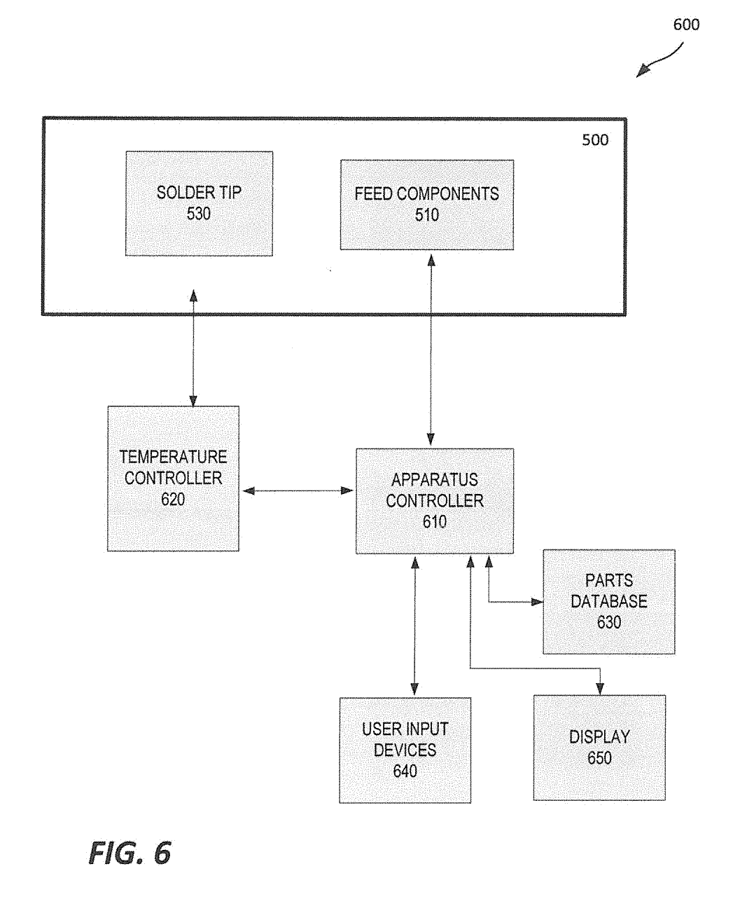

FIG. 6 is a block diagram of the exemplary solder wire dispensing system 600. The solder wire dispensing system 600 may include an apparatus controller 610, which may be programmed to provide overall control of the operation of the solder wire dispensing system 600. The apparatus controller may retrieve or receive information from the solder tip 530, the feed components within housing 510, the spool holder 505, and/or the remote control 540 and/or components of each, either directly or indirectly. For example, temperature controller 620 may be provided to provide an actual or estimated temperature reading of solder tip 530. The temperature controller 620 may receive instructions from the apparatus controller 610 and translate the instructions into heating and/or cooling commands to raise or lower a temperature of the solder tip 530. The apparatus controller may transmit instructions to feed components within housing 510 to dispense solder wire for a calculated length.

A parts database 630 may be provided, which may be similar to the parts database 230 discussed above. Either or both of parts databases 230 and 630 may be global parts databases coupled to a plurality of solder paste dispensing systems 200 and/or solder wire dispensing systems 600 at various locations. In some aspects, the parts database 630 or a portion thereof may be a component of the apparatus controller 610.

As discussed in greater detail below, an operator may select a component to which solder wire is to be applied using a user interface tool. Detailed information associated with each component may be stored in the parts database 630. The detailed information may include a part name, solder operation quantity (for example, when multiple solder operations are to be performed on the same part sequentially), part layout, visual image or picture of the part, amount and/or range of amount of acceptable solder dispensing, solder dispensing temperature, and/or information about dispensing solder wire for each operation in a sequence of solder operations. The retrieved detailed information may be used to configure the apparatus controller 610, and by extension the solder wire dispensing system 600, into a solder wire dispensing state.

Similar to the system of FIG. 2, the solder wire dispensing system 600 in FIG. 6 may include user input devices 640, which may include a remote control (e.g., remote control 540), keyboard, mouse, touch screen, microphone, or the like. Information may be displayed to an operator via display 650 (which may in some aspects include user input devices 640).

Although the blocks of FIG. 6 are illustrated as separate components, one or more of the devices and/or subsystems may be combined into a single assembly. For example, a single computing device may include the apparatus controller 610, the parts database 630, the temperature controller 620, and appropriate interfaces to couple with the user input devices 640 and the display 650.

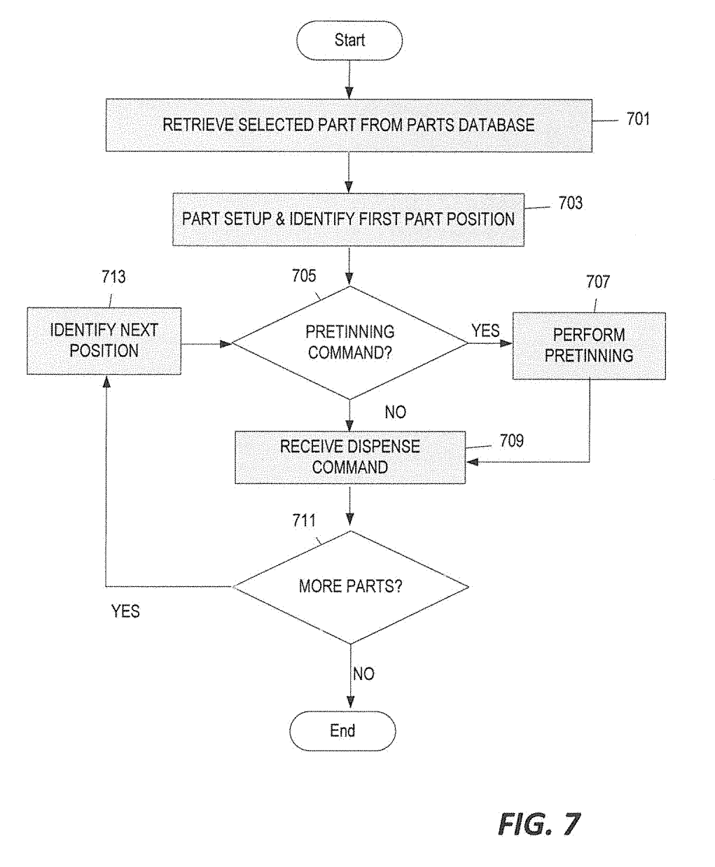

FIG. 7 illustrates an exemplary process flowchart of dispensing solder wire using the system of FIG. 6, according to one or more aspects provided herein. The method illustrated in FIG. 7 may commence at operation 701 upon selection of a part from a parts database (e.g., the parts database 630). This selection may be performed by an operator using a user interface, although in some aspects selection of a part may be performed via other input methods. For example, an operator may scan a barcode or radio frequency identification (RFID) tag on a part or parts container, and a part identifier derived from the scanning may be used to look up detailed information about the scanned part. Alternatively, the solder wire dispensing system may be installed in an assembly line or other location where solder wire dispensing is to be performed for a single part type or component type, and thus the detailed information may be automatically selected. In such an aspect, the parts database 630 may be optional.

In operation 703, the retrieved detailed information about the part is examined and the solder wire dispensing apparatus 500 is operated first in an initial part setup mode. This may include pre-heating solder tip 530 in preparation of pre-tinning, feeding an initial length of solder wire into guide tube 520, and/or other initial preliminary sub-operations. The part or part container may then be loaded into the apparatus.

Once the system has been setup, and still within operation 703 of FIG. 7, a first soldering operation may be indicated on a display (e.g. display 650). This may include a visual indicator of the part and/or a location within the assembly or sub-assembly. Associated with the first soldering location may be temperature and feed settings (e.g., length of solder wire, speed of feed, and so on). This first dispensing operation may be stored in the parts database 630 during a learning process or procedure. For example, while the system operates in a setup or tooling mode, a supervising technician or engineer may manually operate temperature setting components and/or feed components within the housing 510, and the temperature setting and/or feed settings may then be stored in the parts database 630. This information may then be retrieved by the system when operating in a dispensing or production mode.

Prior to performing the first dispensing operation, pretinning of the solder tip 530 may be required or desirable. This may be a predetermined operation preceding the first dispensing operation (e.g., the system may be programmed to perform a pretinning operation prior to one or more of the soldering operations of the sequence) or may be the result of a command from the operator (e.g., the operator determines that cleaning and pretinning of the solder tip 530 may improve subsequent soldering operations, even though no pretinning operation is next in the sequence). If a pretinning command is received, either from the database or from the operator (YES branch from operation 705) the system proceeds to operation 707 and performs pretinning. If however a pretinning command is not received (NO branch from operation 705) the system proceeds to operation 709.

At operation 709, the solder wire may be dispensed into the part or part container according to parameters of information stored in the parts database 630 and in response to receiving dispense command. This command may be received from a user input device 640 (including the remote control 540), or may be received after a timer elapses. The timer may instantiate to provide an operator a length of time to position the solder tip 530 at the correct soldering location. After the appropriate length of solder wire has dispensed, the system may proceed to operation 711.

In operation 711, the system 600 determines whether the soldering sequence has additional parts or soldering operations. If so (YES branch from operation 711) the system proceeds to operation 713. The system may identify to the operator the next soldering location and may operate the temperature and feed controls to heat the solder tip 530 to a temperature corresponding to the soldering operation. The system may also deliver a length of solder wire corresponding to the soldering operation. Otherwise, if no additional parts remain (NO branch from operation 711) the process may terminate.

This method may provide advantages over systems which are configured to only dispense a single predefined length of solder wire, in that variable amounts of dispensed solder wire may be better correlated to an acceptable joining of different components within an assembly or subassembly. In contrast, a single unit of the predefined length of solder wire may be insufficient to solder components, whereas multiple units of the predefined length of solder wire may result in an excess quantity of solder and the potential reduction of electrical performance.

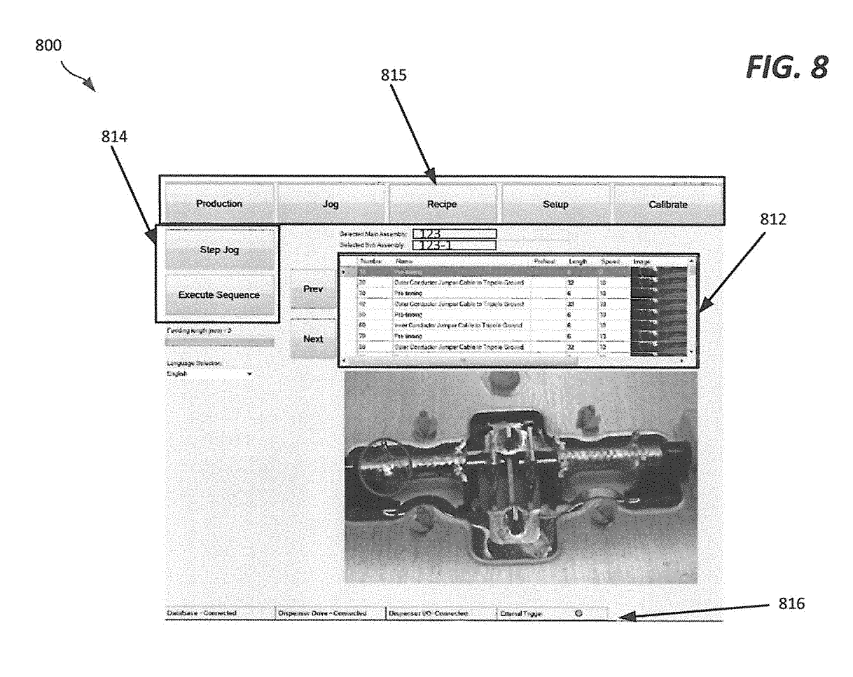

FIG. 8 illustrates an exemplary user interface that may be used in conjunction with the solder wire dispensing system of FIG. 6.

The user interface 800 illustrated in FIG. 8 is merely an example, and more or less information, and/or a greater or fewer number of controls, may be presented. For example, a supervisor or engineer may have a greater number of controls than a line worker. Such rights and access may be based on an identification of a user and/or entry of a password.

As discussed above, an operator may select a recipe, which as used herein may include a sequence of soldering operations. This selection may include selecting a part using a recipe selection tool 815, which may display a photographic indicator of the assembly or subassembly. An operator may toggle through various parts using arrow keys or other user interface components. In some aspects, the operator may instead instantiate a separate user interface in which a part may be searched and selected. Visual representation of the selected part, assembly, or subassembly may assist in reducing mistakes between parts that have similar identification codes (e.g., Pin 24843 and Pin 28483) but are associated with different detailed information in the parts database.

As indicated by recipe listing 812, and as discussed above, the solder wire dispensing system 600 may dispense solder wire for soldering at multiple locations of a part, assembly, or subassembly. Solder wire of differing lengths may be dispensed into the guide tube 520 beginning with a first soldering location (e.g., operation number ‘10’) and proceeding to a last soldering location (e.g., beyond operation number ‘80’). One or more pretinning operations may be provided in the recipe, although as discussed herein an operator may determine that an unscheduled cleaning and pretinning operation may be desirable based on an excess accumulation of solder or flux on the soldering iron tip.

Detailed information about the recipe may be presented in recipe listing 812. The recipe listing may include, for example, for each soldering operation in the recipe, information about a dispensing length associated with the soldering operation, dispensing temperature associated with the soldering operation, visual image of the location where the soldering operation is to be performed, whether a preheating sub-operation is required (for example, because the temperature difference between the soldering operation and a previous soldering operation exceeds a certain threshold). Connection status to the parts database, solder wire feed components, soldering tip, and so on may be provided in a connection status panel 816.

User interface controls 814 may be provided to instantiate or modify operation of the solder wire dispensing system 600. The controls may include a manual “jog” command to manually feed solder wire through the assembly for testing or initializing purposes.

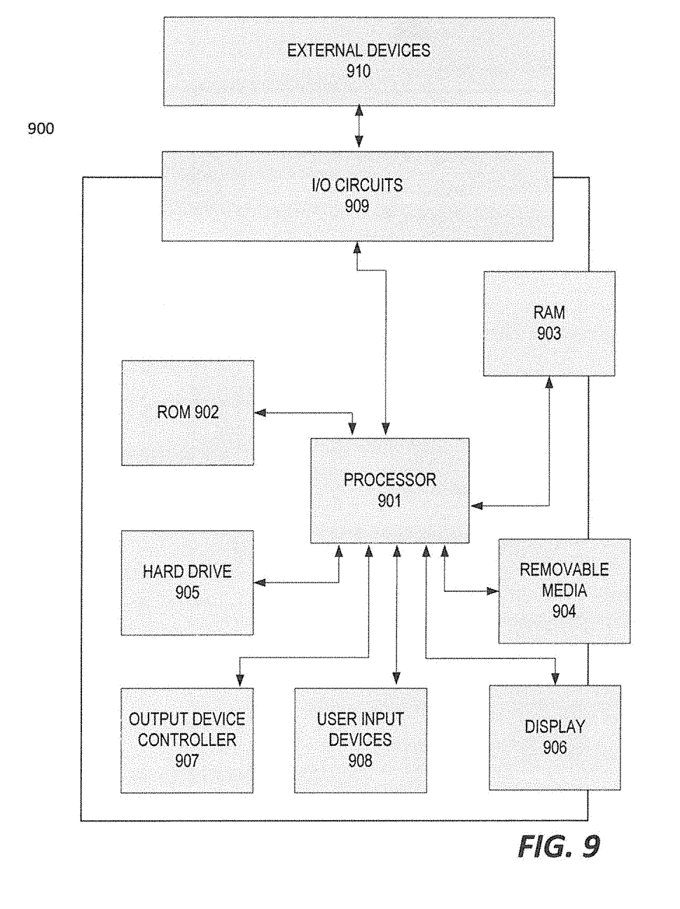

FIG. 9 illustrates hardware elements that can be used to implement any of the various computing devices discussed above. In some aspects, general hardware elements may be used to implement the various devices discussed herein, and those general hardware elements may be specially programmed with instructions that execute the algorithms discussed herein. In special aspects, hardware of a special and non-general design may be employed (e.g., ASIC or the like). Various algorithms and components provided herein may be implemented in hardware, software, firmware, or a combination of the same.

A computing device 900 may include one or more processors 901, which may execute instructions of a computer program to perform any of the features described herein. The instructions may be stored in any type of computer-readable medium or memory, to configure the operation of the processor 901. For example, instructions may be stored in a read-only memory (ROM) 902, random access memory (RAM) 903, removable media 904, such as a Universal Serial Bus (USB) drive, compact disk (CD) or digital versatile disk (DVD), floppy disk drive, or any other desired electronic storage medium. Instructions may also be stored in an attached (or internal) hard drive 905. The computing device 900 may include one or more output devices, such as a display 906, and may include one or more output device controllers 907, such as a display processor. There may also be one or more user input devices 908, such as a remote control, keyboard, mouse, touch screen, microphone, or the like. The computing device 900 may also include input/output circuits 909 which may include circuits and/or devices configured to enable the computing device 900 to communicate with external devices 910. The input/output circuits 909 may include one or more network interfaces, such as a network card, to enable to the computing device 900 to communicate with an external device via an external network (not shown). The network interface may be a wired interface, wireless interface, or a combination of the two. The external device may be a remotely located device. As discussed above, a computing device 900 may also include one or more device interfaces to enable the computing device 900 to communicate directly with one or more local devices, such as the solder paste dispensing apparatus 100 and/or solder wire dispensing apparatus 500.

1. A method comprising:
receiving, by a computing device and from a balance, a first weight reading of a part container;
transmitting a command to dispense a solder product into the part container for a first length of time;
receiving, by the computing device and from the balance, a second weight reading of the part container;
determining, by the computing device, an amount of dispensed solder product based on a comparison of the first weight reading and the second weight reading; and
determining, by the computing device, that the amount of dispensed solder product does not fall within an accepted range; and
generating, by the computing device and in response to the determining that the amount of dispensed solder product does not fall within the accepted range, a second length of time to be used in a future dispensing of the solder product, wherein the second length of time differs from the first length of time.

2. The method of claim 1, further comprising:
transmitting a command to dispense the solder product into the part container for the second length of time.

3. The method of claim 1, wherein the solder product comprises a solder paste.

4. The method of claim 1, wherein the first weight reading is received from a database.

5. The method of claim 1, wherein the determining that the amount of dispensed solder product does not fall within the accepted range comprises determining that the amount of dispensed solder product is below the acceptable range, and wherein the second length of time is longer than the first length of time.

6. The method of claim 1, wherein the determining that the amount of dispensed solder product does not fall within the accepted range comprises determining that the amount of dispensed solder product is above the acceptable range, and wherein the second length of time is shorter than the first length of time.

7. The method of claim 1, wherein the amount of dispensed solder product comprises a first amount of dispensed solder product, and wherein the generating the second length of time is based on the first amount of dispensed solder product and based on a second amount of dispensed solder product resulting from a comparison of a third weight reading and a fourth weight reading.

8. The method of claim 1, wherein an indicator of the first length of time is received from a database comprising a plurality of parts and respectively associated indicators of lengths of times.

9. The method of claim 8, wherein an indicator of a quantity of parts in the part container is received from the database, and wherein the method comprises transmitting a plurality of commands to dispense the solder product into the part container, a number of the plurality corresponding to the quantity of parts in the parts container.

10. A method comprising:
receiving, by a computing device and from a balance, a first weight reading of a pallet comprising a plurality of parts;
positioning, by the computing device, a solder product dispensing nozzle over a first part of the plurality of parts;
transmitting a command the solder product dispensing nozzle to dispense a solder product into the first part for a first length of time;
receiving, by the computing device and from the balance, a second weight reading of the pallet comprising the plurality of parts and dispensed solder product;
determining, by the computing device, a dispensed amount of the solder product based on a comparison of the first weight reading and the second weight reading; and
determining, by the computing device, that the dispensed amount of the solder product does not fall within an accepted range;
generating, by the computing device and in response to the determining that the dispensed amount of the solder product does not fall within the accepted range, a second length of time, wherein the second length of time differs from the first length of time,
positioning, by the computing device, the solder product dispensing nozzle over a second part of the plurality of parts; and
transmitting a command the solder product dispensing nozzle to dispense a solder product for the second length of time.

11. The method of claim 10, wherein the solder product comprises a solder paste.

12. The method of claim 11, wherein the determining that the dispensed amount of the solder product does not fall within the accepted range comprises determining that the dispensed amount of the solder product is below the acceptable range, and wherein the second length of time is longer than the first length of time.

13. The method of claim 11, wherein the determining that the dispensed amount of the solder product does not fall within the accepted range comprises determining that the dispensed amount of the solder product is above the acceptable range, and wherein the second length of time is shorter than the first length of time.

14. The method of claim 11, wherein the positioning, by the computing device, the solder product dispensing nozzle over the first part of the plurality of parts comprises transmitting a command to at least one arm of a multi-axial arm assembly.

15. (canceled)

16. The method of claim 11, wherein an indicator of the first length of time is received from a database comprising a plurality of parts and respectively associated indicators of lengths of times.

17. A method comprising:
receiving, by a computing device, user input indicating a selected part;
retrieving, from a database, detailed information associated with the selected part;
displaying, on a display associated with the computing device, a first operation from a sequence of soldering operations to be performed for the selected part, wherein the detailed information comprises, for each soldering operation of the sequence of soldering operations, a visual indicator of a location on the selected part to perform the soldering operation, an amount of a solder product associated with the soldering operation, and a temperature setting for the soldering operation;
receiving a command to dispense an amount of solder product that is associated with the first operation; and
transmitting an instruction to dispense the amount of solder product based on the command.

18. The method of claim 17, wherein the solder product comprises solder wire.

19. The method of claim 18, further comprising:
displaying, on the display associated with the computing device, a second operation from a sequence of soldering operations to be performed for the selected part.

20. The method of claim 18, further comprising:
receiving a command to dispense an amount of solder product associated with a pretinning operation; and
transmitting an instruction to dispense the pretinning amount of solder product based on the command.

21. The method of claim 18, wherein the computing device is located remotely from the database and communicates via an external network.
